(19) United States
(12) Patent Application Publication
(10) Pub. No.: US 2017/0155818 A1
(43) Pub. Date: Jun. 1, 2017

(54) Camera Arrangement

(71) Applicant: Spheron-VR AG, Waldfischbach-Burgalben (DE)

(72) Inventor: Gerhard Bonnet, Clausen (DE)

(21) Appl. No.: 15/304,463

(22) PCT Filed: Apr. 16, 2015
(86) PCT No.: PCT/EP2015/058251

§ 371 Date: Jan. 4, 2017

(30) Foreign Application Priority Data
Apr. 16, 2014 (DE) 10 2014 207 315.4

(51) Int. Cl. H04N 5/235; G02B 27/10; H04N 5/225

(52) U.S. Cl. CPC H04N 5/2355; H04N 5/2254; H04N 5/2258; G02B 27/106

(57) ABSTRACT

The present invention relates to a camera having a beam splitter arrangement and a plurality of planar image sensor chips arranged in the partial beam paths thereof, which have nominal dynamic response for individual recordings of a finite range, wherein multiple image sensor chips spaced apart from one another with gaps are arranged in a first partial beam path and a gap-overlapping image sensor chip is arranged in a further partial beam path for at least one gap. It is provided in this case that the beam splitter arrangement is formed using a solid beam splitter block, the planar image sensor chips of the first partial beam path are adhesively bonded to a first surface of the solid beam splitter block, and the at least one gap-overlapping image sensor chip of the further partial beam path is adhesively bonded to another exit surface of the beam splitter block, and that the camera is furthermore provided with a sequence controller to record images with a dynamic response higher than the finite dynamic range.

### CROSS-REFERENCE TO RELATED APPLICATIONS

This patent application is a national phase filing under section 371 of PCT/EP2015/058251 filed Apr. 16, 2015, which claims priority to German Application No. DE 10 2014 207 315.4 filed Apr. 16, 2014, both applications of which are incorporated herein by reference in their entirety.

### TECHNICAL FIELD

The present invention relates to the matter claimed in the preamble and therefore relates to a camera.

### BACKGROUND

There are a variety of cameras, which are designed for different purposes. Depending on the requirement for the camera, the design of the camera becomes very costly and complex. This applies, for example, to the high-resolution camera available from the applicant SpheronVR, which supplies full-spherical color images and enables the recording of images with high dynamic response of up to 26 aperture stops. For this purpose, in the known camera, the objective rotates jointly with a strip sensor about the nodal point of the objective, so that full-spherical panoramas can be recorded. Such cameras are used, inter alia, in object capture during the construction of buildings, for forensic documentation of crime scenes, and to ascertain light fields, which can then be used for the preparation of computer-generated images, for digital special effects in movies, and so on.

Experience has shown that notwithstanding the high dynamic response which is achievable using the previously known camera arrangement and notwithstanding the already very good optical resolution, it is often desirable to capture a still greater dynamic range with still better spatial resolution and more rapidly using a camera, and preferably so that it is possible in principle to also assign radiometrically correct measured values to the real spatial angle of each pixel from the raw data pool, without allowing the costs for this purpose to become prohibitive, however.

A suitable design of a desirable camera would enable, for example, firstly the location of objects in a room to be determined and then correct colors and activities to be assigned thereto. It will be apparent that this opens up new, desirable possible applications.

An arrangement for allocating a large-format image strip of an optoelectronic line scan or area scan camera to a number of smaller CCD line scanners or area scanners is known from DE 44 18 903 C2, wherein a) an optical beam splitter is provided behind the optical unit of the camera and directly in front of the image plane thereof, in which beam splitter regions having approximately complete transmission and regions having approximately complete reflection are provided alternately, which are each separated by continuously varying transition zones for the targeted avoidance of diffraction effects, b) two long line modules are formed from the CCD line scanners or area scanners in such a manner that in each long line module, intermediate spaces between the CCD line or area scanners are shorter by at least two transition regions than the length of the light-sensitive region of a single CCD line or area scanner, c) a long line module is arranged in each case behind the beam splitter, below the transparent sections thereof, and laterally thereto (ST) adjacent to the reflective sections, so that the centers of the CCD line or area scanners of one long line module overlap with the centers of the intermediate spaces of the other long line module, so that d) by summation of signals in the overlap regions of the CCD line scanners or the area scanners, an (almost) radiometrically lossless and therefore polarization-free signal is ensured for the entire optoelectronic camera.

A method for creating spherical visual representations from a camera is known from EP 1 910 894 B1, comprising: obtaining at least one image using the camera upward to create an upper image; obtaining at least one image using the camera downward to create a lower image; transforming the images into flattened equirectangular images; and combining the upper image and the lower image to create a final spherical image, wherein obtaining at least one image using the camera upward to create an upper image comprises recording a plurality of images using the camera upward at different exposures to create a plurality of upper images, and obtaining at least one image using the camera downward to create a lower image comprises recording a plurality of images using the camera downward at different exposures to create a plurality of lower images, and furthermore comprising: combining the plurality of upper images into a single upper high-contrast image after the step of transforming; and combining the plurality of lower images into a single lower high-contrast image after the step of transforming; wherein the step of combining comprises combining the single upper high-contrast image and the single lower high-contrast image to create a final high-contrast image.

The horizontal position of a revolving camera and the vertical scanning of successive sectors of an environment, to acquire visual information in all directions from a given point, is known from GB 2 332 531 A. An image recording device for panoramic recordings having high dynamic response is also known from JP 11065004 A.

An arrangement is known from U.S. Pat. No. 4,940,309, which is referred to as a “tesselator” and separates light waves into a number of separate images, which are called segments. The indicated purpose of the arrangement is to be able to use multiple lower-performance sensors instead of a single higher performance sensor. One-dimensional and two-dimensional tesselators are specified, wherein the two-dimensional tesselators are to use glass having mirrored segments.

It would be desirable to be able to at least partially fulfill at least a part of the above requirements.

### SUMMARY

Embodiments of the invention provide novel matter for industrial applications.

According to a first embodiment of the invention, in a camera having a beam splitter arrangement and a plurality of planar image sensor chips arranged in the partial beam paths thereof, which have nominal dynamic response for individual recordings of a finite range, wherein multiple image sensor chips spaced apart from one another with gaps are arranged in a first partial beam path and a gap-overlapping image sensor chip is arranged in a further partial beam path for at least one gap, it is provided that the beam splitter arrangement is formed using a solid beam splitter block, the planar image sensor chips of the first partial beam path are adhesively bonded to a first surface of the solid beam splitter block, and the at least one gap-overlapping image sensor chip of the further partial beam path is adhesively bonded to another exit surface of the beam splitter block, and that the camera is furthermore provided with a sequence controller, to record images with a dynamic response higher than the finite dynamic range.

It has been found that the use of planar image sensor chips enables a high-resolution camera, which also has a high dynamic response if necessary, to be provided under suitable conditions without substantial additional expenditure, which is capable of recording again very rapidly. The arrangement of multiple planar image sensor chips in a first partial beam path and the overlap of the gaps left thereby using planar image sensor chips in a further partial beam path contributes to providing a sensor arrangement which records images having a large area overall.

Because a plurality of sensors is used, they may be read out rapidly and the corresponding data may be processed as required. This is advantageous to record images having high dynamic response. “High dynamic response” is primarily to be understood as a dynamic range which cannot be achieved using a single sensor without special measures, which thus exceeds the dynamic range of a single sensor, which is always finite. An image having high dynamic response will therefore have a dynamic range which is greater than that of the A/D converter, which is associated with the digital image sensor, or which can be achieved using a structurally equivalent sensor outside an arrangement according to the invention. Exceeding the dynamic response does not have to occur in all sensors which receive light via the beam splitter arrangement. Rather, it is sufficient if the overall image has a higher dynamic response than a single sensor permits; since typically and preferably only structurally equivalent sensors are used in a given arrangement, because this simplifies the construction, the sequence controller, etc., the dynamic response otherwise achievable using the selected sensor product is thus exceeded.

If a shared mechanical shutter is associated with all sensors, multiple exposures will typically be carried out successively. In such a case, a sequence controller will typically and preferably be necessary, to control the recording of multiple individual images combinable to form an HDR recording. However, it is to be noted that using emerging technologies, it is possible that multiple global recordings no longer have to be made, but rather only a single recording having locally differing exposure, because, for example, an “electronic shutter” is implementable by and using each sensor. In such a case, the array of sensors would also be controlled accordingly by the sequence controller.

If very bright punctiform light sources are present within an image—for example, the sun in a clear sky—and—for example, in the case of a backlit recording—very dark regions are close thereto in the image at the same time, the dynamic response achievable using the sensors will be exceeded on individual sensors and it is ensured by the sequence controller that overall a recording having correct exposure is carried out for each point in the image and at the same time recordings are made so that it is possible to assemble the points having locally correct exposure to form an overall image without problems.

However, a case could also occur per se, in which the dynamic response possible for each individual sensor is not locally exceeded in any of a plurality of sensors, for example, because a brightness difference, which albeit large in a scene only has a gradual curve. In such a case, it also at least has to be ensured that all sensors are operated using correct parameters in each case, to optimally record such a scene. If a controller is designed to bring this about, it is also understood as a sequence controller in the meaning of the invention.

Because planar image sensors are used, large regions of a scene can be captured simultaneously, without a single large chip, which is therefore very costly both with respect to the chip and also the upstream optical unit required for this purpose, being required for this purpose. It is thus apparent that the camera arrangement is typically associated with an image linking unit, using which the individual images or HDR individual images originating from the individual planar image sensor chips are linked to form an overall image, for example, an image strip or an HDR image strip. This linkage can be performed within the camera, possibly also in real time during the image recording, or outside the camera, for example, on a computer unit which links the raw data from the image sensor chips.

With regard to the fact that, in particular for recording images having high dynamic response, a not insignificant amount of data processing and careful recordings of the raw data are required even with very large-area and therefore very costly image sensor chips, the required structural expenditure only increases marginally due to the use of multiple small image sensor chips while, as a result of the more cost-effective smaller planar image sensor chips, which become usable, the overall camera arrangement can be embodied more cost-effectively. At the same time, in the case of the panoramic recording, the use of planar image sensor chips enables a rotation of the camera about a rotational angle which does not have to be predetermined as exactly as with a line sensor, but rather only has to lead approximately to a given end position; it is therefore possible to accelerate the drive and therefore to carry out the measurement more rapidly as a whole.

In addition, it is to be noted that the use proposed here of many planar, but typically small-area image sensor chips is already advantageous because image sensor chips having novel sensor technologies are often initially available as small-area chips. It is therefore possible much more simply to update and/or rework the camera of the present invention.

It will become apparent that preferably more than two image sensor chips each having a gap in relation to one another are arranged in a row in the first partial beam path and the gaps thereof are overlapped outside the first partial beam path, so that thus in the preferred variant, at least five image sensor chips are provided in a row; it is particularly preferable in this case if these image sensor chips have gaps of at least essentially equal size in relation to one another and are preferably all located in a row. This row will preferably be arranged vertically in use, so that in each rotational position of a rotation about a vertical axis, a large image range can be scanned or captured simultaneously from top to bottom. The gaps are thus preferably equal in relation to one another because this simplifies the mounting and analysis. However, the gaps do not all have to be exactly equal in size in this case, because preferably a substantial overlap exists between the image sensor chips in the first partial beam path and those in the second partial beam path. Thus, for example, a gap of half a sensor edge length can be left in one direction. The image sensors in the first or second partial beam path can then be arranged overlapping in relation to one another so that a respective overlap of a quarter of an image sensor chip edge width is present in one direction. At typical resolutions of cost-effective planar image sensor chips, several hundred pixels of overlap thus result, which enables the mounting or the determination of a uniform data set with clear association between pixels and captured spatial position. It is apparent from the above statements that gaps of “at least essentially” equal size are still present if this is ensured and in particular overlap strips of at least a few tens of pixels in width, for example, overlap strips of 20-50 pixels in size remain, while at least not fewer than a fifth of the image sensor chip edge width is overlap-free.

The gaps can thus be considered to be of equal size over a sufficiently large range for the purposes of the present invention, which facilitates the mounting of the image sensor chips. These image sensor chips can be housed beforehand on a printed circuit board, for example, and it is to be understood that even with manufacturing accuracies of several micrometers play after soldering of the image sensor chips on a carrier printed circuit board, a sufficient precision for the purposes of the invention is still ensured. A lack of mounting precision in the circumferential direction, i.e., transversely in relation to the rows formed by the plurality of image sensor chips, can also be readily compensated for with planar sensor chips, in that the lateral edge pixels are ignored depending on the exact mounting position.

While it was stated above that the image sensor chips are arranged in a row in a first partial beam path with gaps in relation to one another and the gaps thus formed are overlapped by image sensor chips in a second partial beam path, it is to be inferred that if necessary multiple such rows of image sensors mounted with gaps in relation to one another can be implemented adjacent to one another and then the gaps between the columns can be overlapped with sensors of further partial beam paths if necessary, to thus implement an overall image sensor chip arrangement which has a particularly large area in two directions. Thus, in a first partial beam path, a field of image sensor chips arranged in columns and rows could be provided, which are overlapped in a row of gaps left in a second partial beam path with image sensor chips arranged according to the invention, and the gaps left between columns are then overlapped with image sensor chips in a third and fourth beam path.

However, notwithstanding this fundamental possibility, using which a very large-area image sensor chip may be implemented, it is generally preferred to use only a single column formed with planar sensors and therefore also only one beam splitter. This is because, to record a full-spherical image, as is preferably recorded using the camera, a rotation of the camera arrangement is still required even if multiple columns are used and accordingly even with an overall image sensor chip arrangement extending broadly in two directions, a camera rotation with corresponding associated rotation drive, rotation controller, etc. is still necessary. At the same time, the camera optical unit, which is preferably very wide-angle, possibly has to be adapted for the use of multiple columns, which results in further costs. Against this background, hardly any positive effects are obtained, because still more rapid image recording could take place using planar image sensor chips, but the required additional optical elements have to be solid, which increases the structural size, makes the camera heavier, requires stronger drives, etc. Even if an extremely rapid image recording is desired, it is therefore possibly more cost-effective to merely increase the computer capacity.

It is particularly preferable if the beam splitter arrangement is formed using a solid beam splitter block, i.e., not using a partially transmissive thin mirror, but rather, for example, by means of cemented prisms or the like. In such a case, the planar image sensor chips of the first partial beam group can be adhesively bonded to a first surface of the solid beam splitter block, while the at least one gap-overlapping image sensor chip in the further partial beam path is adhesively bonded to another (output) surface of the beam splitter block. The respective planar image sensor chips can be contacted on the rear in groups in this case, in particular by arrangement (in groups) on a shared printed circuit board. The adhesive bonding to the solid beam splitter block has substantial advantages for the camera. It is obvious that the adhesive bonding can be performed using an optical cement, which will be adapted to the indices of refraction of beam splitter block and/or the cover layers (protective layers) of the image sensor chips. In the ideal case, it is possible that the cover layers on the image sensor chip have the same index of refraction and the same dispersion behavior as the beam splitter block. In such a case, the cement will ideally also have the same index of refraction and preferably the same dispersion. Where this is not ensured, for example, because differences exist between the index of refraction of the cover layers on the image sensor chip and the index of refraction of the beam splitter block, the cement having an optimized index of refraction can be selected, which minimizes reflections, etc. at the boundary layers. The corresponding methods for determining the cement index of refraction are well-known from the production of cemented lens groups. It is to be noted in this regard that for typical optical adhesives, the index of refraction can be set well and moreover a well-controlled dispersion behavior can be expected. To enable a better adaptation, moreover antireflection layers on the cover glasses of the sensors, as are typically used for reducing the back reflections, can be omitted, removed, or at least can be designed as weaker. Cementing cover glasses without antireflection layers to the beam splitter block is helpful insofar as the antireflection layers typically wish to achieve antireflection treatment in relation to air i.e., are not correctly designed in the case of the application provided here and therefore have an interfering effect.

The thickness of the cement layers will typically hardly vary and can optionally also be taken into consideration, together with the optical properties of the solid beam splitter block, in the design of a camera objective. In this case, the thickness of the layer per se is not critical to manufacturing, because adhesives or lacquers which are not subject to shrinking upon curing are available and typically used. It is estimated that adhesive layer thicknesses between several micrometers and several hundred micrometers are set using such adhesives. Typical and preferred values are between 5 μm and 100 μm, particularly preferably between 10 and 100 μm. Tolerances of the lens optical unit, etc. can be compensated for by the adhesive. Still greater thicknesses are not necessarily required for this purpose, however, because the tolerances of the lens optical unit etc. achievable with acceptable expenditure will be sufficiently low; at the same time, however, the flow behavior of the not yet cured adhesive is more strongly noticeable at greater layer thicknesses, because the influence of capillary effects between sensor and beam splitter block decreases. Excessively thin layers are undesirable, in contrast, because the parts to be adhesively bonded directly touching one another is preferably to be avoided. The mentioned preferred values enable easy mounting with sufficiently large tolerance fields, without additional difficulties being expected.

The use of, for example, UV-curing adhesive or cement additionally enables the image sensor chips, in particular insofar as they are soldered onto sufficiently flexible printed circuit boards, to be adhesively bonded either jointly or individually aligned on the beam splitter block, specifically in that a sufficiently large amount of UV energy is radiated onto the beam splitter block. After adhesive bonding on the beam splitter block, the image sensor chips are arranged in a vibration-proof manner and misalignment is significantly less probable.

The use of a solid beam splitter block, on which the planar image sensor chips are adhesively bonded, additionally has still further substantial advantages for high-quality camera arrangements. On the one hand, beams are fed comparatively linearly from the beam splitter block to the image sensor chips, notwithstanding the required wide-angle image recording, which otherwise typically results in beams incident diagonally on the sensor. This is advantageous because a diagonal incidence in the prior art, in particular in edge regions of sensors, can result in color shifts, if the sensors have Bayer filters and the like. Due to the preferred arrangement having a solid beam splitter block, accordingly such errors occurring in the sensor edge regions in the prior art are reliably avoided.

In addition, due to the solid beam splitter block, the interference by light back reflections on the sensor cover layers is also significantly reduced. This is because in operation of a sensor, it can never be completely avoided that incident light is backscattered from the light-sensitive sensor surface. If this light reaches the sensor protective layer and therefore a glass-air boundary layer in the prior art, it can thus be reflected back to other sensor regions again. For this reason, typical image sensor chips have an antireflective coating. However, even a highly effective antireflective coating reaches its limits where images having extremely high dynamic response are to be recorded, because in such a case even reflections which are otherwise perceived to be weak can still significantly corrupt measured values or brightness values and/or color values in images. Due to the use of a solid beam splitter block, on which the image sensor chips are adhesively bonded, the reflection at the interface between sensor protective layer and cement or beam splitter block can be reduced very massively and the reflection at the interface between beam splitter arrangement and air toward the objective is now obtained as the dominant reflection. Because this interface will be significantly more remote from the light-sensitive elements of the image sensor chip than the sensor protective layer in a typical design of the camera arrangement, the interference to be expected is reduced, typically in relation to the square of existing and generally also retained protective glass thickness in relation to beam splitter block thickness. The strength of the interference is therefore substantially reduced. Without taking special measures, incident radiation originating in particular from particularly bright points such as punctiform light sources thus have a significantly smaller effect on very dark regions. This is because it is to be expected that the light which is back reflected multiple times will be distributed over a larger area on the sensor. This is because, on the one hand, a part of the light is also scattered and not only reflected and, on the other hand, the light beams initially focused on the sensor surface continue during the multiple reflection, i.e., widen again. The interference is thus balanced out better. In addition, the back reflections are often wavelength-dependent, so that sometimes interference is “colored” and can also interfere with the correct color reproduction in the image. The adhesive bonding also has an effect with respect to this effect, because of which in particular in the case of colored HDR recordings, the cementing offers particular advantages; this applies in particular where—for example, due to color filters moving during the measurement in the beam path—more precise color capture is to be enabled; it is to be noted that the movement of color filters in the beam path can take place in response to signals from the sequence controller, for example, to a filter-moving actuator.

While the balancing and attenuation of the interference contribute to the image also being usable per se without special measures for many applications, due to the balancing and the absolute attenuation of the interference which is caused by the cementing of the sensors on the beam splitter block, it also becomes simpler to calculate out the interference caused by the back reflections, because the description of the so-called point spread function becomes simpler. It is estimated that for simple HDR cameras, no such measures will be necessary and for cameras having extreme dynamic range of in particular greater than 26 bits, for example, from 30 bits (corresponding to 30 apertures), a correction to the spread of the reflections can be performed, i.e., a means is provided for at least partial compensation of a point spread behavior.

It is to be noted that moreover the beam splitter block can have an antireflective coating on the side facing toward the objective and/or the side which is not in contact with sensors, to reduce interference still further.

It is to be noted in this regard that the cementing of a planar image sensor chip using a layer which is at least 5 mm thick is advantageous in principle for HDR recordings, because back reflections thus do not have as strong an effect and required corrections for considering the point spread function therefore have to be less severe. As a result of the rapid decrease of the back reflection influence, it can also be preferable to increase the thickness still further, in particular to 8 to 20 mm, preferably between 8 and 15 mm. It is assessed in this case that an excessively thick cover layer has negative effects for the design of the camera, for the weight thereof, etc. and it is not advantageous to reduce the back reflections further by thicker cover layers than justified by the camera objectives, which have a finite quality of its compensation, and which are typically to be used with the camera. This is typically the case for thicknesses of the layer between 8 and 15 mm. Sufficiently thick layers are advantageous if not only the intensity of reflections is to be reduced, but distribution which can be compensated better is to be achieved at the same time by mathematical operations. Therefore, 8 mm thick layers, preferably 10 mm thick layers are typically advantageous. It is reserved in this regard to also claim protection for a camera for recording HDR images having at least 20 bits, preferably at least 26 bits, in particular 30 bits of dynamic response, in which at least one image recording sensor is provided with a cover which has a thickness of at least 5 mm, preferably between 8 mm and 20 mm, particularly preferably between 8 and 15 mm. It is to be noted that a sequence controller can be associated with such a camera, to cause an HDR recording series, and/or that correction means can also be provided for correcting on the basis of a point spread function. These correction means can cause an in-camera correction of the point spread function; in such a case, they comprise a data memory for the data describing the point spread function and a computer means, to cause the correction of recorded images based on the data describing the point spread function, as they are stored in the data memory. Alternatively, it is possible to store away data and/or specifications relevant for the correction or partial correction only with the image data on an image data memory or to provide it in another manner for off-line image processing. While it is apparent that a point spread function is particularly efficient if a fixed objective is used and is taken into consideration in the determination of the point spread function, this is not required and advantages can already result if only the sensor-based influences on the point spread function are compensated for or these sensor-based influences on the point spread function are compensated for together with the average influence of objectives which are used or typical on the point spread function. It is to be noted that it is also possible if necessary in the case of the single sensor camera, which is also disclosed here, having thicker sensor cover layer to determine a correction for various specific objectives and then to take into consideration accordingly upon objective change. The self-calibration using a reference light source with sensor dimming, which is also mentioned hereafter for multisensor cameras, and/or the automatically controlled introduction of neutral density filters, color filters, etc. into the beam path, as disclosed for multisensor cameras of the invention, is mentioned as an advantageous possibility.

It is additionally to be noted that the methods still to be described for HDR raw data generation additionally enable such effects to be corrected.

It is possible and preferable that the image sensor chips are multicolor sensors, i.e., each of the planar image sensor chips is capable of recording multiple colors simultaneously. This can be achieved, for example, by way of Bayer filters on the sensors; however, it is also to be noted that alternatively other color sensors such as Foveon sensors are also usable.

It is particularly preferable if the camera has a wide-angle objective, in particular a wide-angle objective having fixed focal length and fixed aperture. The use of a fixed focal length objective is advantageous if the camera is especially designed for recording full spheres. The use of a fixed aperture is advantageous because the exposure time is preferably varied, also and in particular for recording HDR images, but not the aperture stop, so that the depth of field is not varied by aperture variations. With fixed aperture, in addition the aperture can be selected so that the imaging power of the camera objective is optimized; it is possible in particular to design a wide-angle objective at large depth of field with limited diffraction for the camera. A large depth of field exists if sharp imaging is provided from close range of a few meters, for example, less than 3 m, preferably between 1.5 and 2 m distance away from the camera to infinity. It is to be noted that the adhesive bonding of the sensors to the beam splitter block offers advantages in particular where a fixed objective is used, because then the sensors can be adhesively bonded so that an optimally sharp image is obtained. The condition for this is solely that the sensors are adhesively bonded while an image incident thereon is recorded and the position of the sensors during the adhesive bonding is changed in response to the recorded images until an optimally sharp image is obtained. This can be convincingly performed iteratively, wherein it is apparent that the position change is possible in a very targeted manner, and/or if necessary a beam splitter block having sensor chips already located thereon also only has to be changed in relation to a (fixed) objective, to achieve an image improvement.

Upon use of a wide-angle objective, preferably a sufficient number of image sensor chips is arranged in a row so that with one recording a planar strip having the desired spatial angle is acquired and in particular the vertical opening angle is greater than 150° , preferably 180° of a 360° full circle or more.

In one particularly preferred embodiment, a drive is used to rotate the camera, which has a vertical axis during use. The vertical axial alignment can be ensured by means of a level, an artificial electronic horizon, or the like and corresponding adjustment of a framework or by automatic self-alignment. A not exactly vertical alignment does not necessarily interfere in this case, however, above all not if a horizontal deviation is also captured and stored for the purpose of later compensation. It is only important that the incline does not become sufficiently large that in specific unfavorable alignments a (rotational) creeping movement of the camera head placed in a rotational position for recording an image strip occurs.

It is possible to use this drive so that the camera is not rotated with pixel accuracy up to an exactly predefined position, but rather, thanks to the planar image sensor chips and the strip-type arrangement thereof in the camera, a rotation of the camera up to approximately a desired rotational angle is performed, and then the exact end position of the respective rotational movement, at which the coarsely predefined rotation was ended, is then ascertained by means of a subpixel-accurate determination of the rotational angle. For this purpose, only a sufficiently accurate angle decoder is then required, which is readily capable of determining a subpixel-accurate rotational position at typical pixel distances. Such angle decoders are available cost-effectively; for the drive itself, a piezo drive (so-called ultrasound motor) can be used; this generally enables, in particular in a design as a ring drive, the end position assumed after ending the drive to be maintained without creep. This is advantageous because the exposure sequences which are taken in a respective rotational position are therefore recorded in exactly equal alignment and therefore the linkage of the data from a pixel which was recorded at a specific exposure to the data of the same pixel which was recorded at another exposure is substantially facilitated. It is thus particularly advantageous to use a creep-free drive where a sequence of multiple recordings is to be combined into an overall recording, i.e., a corresponding sequence controller is provided. In one preferred variant, the sequence controller can also suppress and/or permit a further movement.

It is to be noted that the camera is typically not only rotated about a vertical axis, more precisely, that image sensor chips and objective are rotated about a vertical axis in the camera, but rather typically a rotation is even performed such that the rotation will take place about the nodal point of the camera objective. This results in single images which can be linked without parallax from the different rotational positions. It is to be emphasized that such a joint rotation of camera objective and image sensor chips about the objective nodal point is known per se and already readily implementable, in that a very small amount of play of the objective-image sensor chip unit is permitted in the direction radially in relation to the rotational axis for the mounting, and otherwise a correct alignment of the objective in relation to the rotational axis is ensured. Furthermore, it is to be noted that a “nodal point” in the stricter sense cannot be defined for all objectives; in panoramic photography, the nodal point is often understood as the point on the optical axis of an objective, about which a camera including objective is to be rotated to optimize the image processing of recorded panoramic data. This can possibly be meant with respect to an entry pupil or, in the case of a strongly wide-angle objective, the point through which a beam passes, which has an angle of 90° in relation to the optical axis at long range. This point is also referred to as the NPP90 (=no parallax point at 90°).

It is apparent that the number of image sequences to be recorded for a full sphere, i.e., rotational positions to be assumed during the full sphere capture, will be dependent on the edge length of the planar image sensor chips and on the distance of the image sensor chips from the rotational axis. It is preferable if the image sensor chips have an edge length in the circumferential direction of at least 4 mm, preferably greater than 5 mm. A camera can thus be constructed with acceptable sizes for the optical unit, which requires no more than 50, typically only 25 different rotational positions for recording a full sphere. An excessively large number of rotational positions to be assumed slows the measurement; an excessively small number is only achieved with very large image sensor chips, which possibly will become prohibitively expensive. The edge length of approximately 5 mm, in contrast, is achievable using very cost-effective chips and the number of the recordings is acceptable. It is apparent that drive pulses can readily be generated for a piezo drive, using which the desired rotation can be approximately achieved. Such pulses can be fed under control and/or in response to signals from the sequence controller to the piezo drive.

It is to be noted that reference is also made to a full sphere if the region below the camera or directly around the tripod is not captured and/or possibly no measurements exactly upward take place, but rather also regions which are not captured possibly remain in the upper (polar) region, even if this is obviously not preferable. It is preferable in any case to capture full spheres in which the entire region up to the polar points is captured at least above the camera. It is to be noted that otherwise rotation of the camera about a full circle does not have to be performed for specific purposes. It is often sufficient, for example, where view panoramas are to be recorded for advertising purposes, to only capture a partial region of the full circle; however, a full sphere recording is typically preferred for applications such as light field recording.

The planar image sensor chips will typically have several hundred, preferably more than 1000 pixels, particularly preferably more than 1500 pixels, for example, 2200 pixels in the circumferential direction of the rotation. This enables images having sufficiently high resolution to be provided for a broad number of users, in the case of which fine details are still sufficiently recognizable in objects located at greater distance from the camera. It is additionally possible to compensate for inaccurate mounting of the image sensor chips along a row, in that the edge pixels are ignored depending on the exact image sensor chip location. If approximately wo pixels on the left edge and 100 pixels on the right edge are each “sacrificed” to compensate for inaccurate alignment, permissible mounting tolerances of, for example, 100*2 μm result (at typical pixel sizes), which can be readily managed in manufacturing.

It is preferable if the camera arrangement of the present invention has a light filter movable between objective entry lens and image sensor chips into the objective beam path, which can in particular be moved as a replacement for another filter into the objective beam path between objective and image sensor chips, preferably in front of the beam splitter. It is particularly preferable to move the filter close to the plane of aperture stops in the beam path, because then contaminants on the filter surface in the filter glass, etc., spread at least onto the image content. It is possible to provide one of multiple broadband spectral filters as such a light filter, to expand the color space accessible to the camera by measurement using different spectral filters. If such an expansion of the color space of the camera is desired for the present invention, it is possible to perform a multiple exposure in each position, wherein measurement can be performed at least once using each color filter in the beam path and/or at least two spectral filters are inserted successively into the beam path for different measurements in one camera rotational position (“measurements” is moreover sometimes referred to in the present case in the text to emphasize that the recordings which can be carried out using the camera according to the invention do not result in snapshot-like souvenir pictures, but rather capture an environment with high accuracy and enable the measurement thereof. The camera is thus also a measuring device or a measuring camera, in particular a color-capable and/or HDR measuring camera).

It is to be noted that where HDR raw data are desired, an HDR exposure series can obviously be performed using each color filter in the beam path, for example, by variation of the exposure time. This can take place by recording a complete exposure series at each rotational position, i.e., independently of the instantaneously observed brightness values; alternatively, in consideration of instantaneously captured brightness values, only the recordings can be made which are absolutely necessary—it is thus not necessary, for example, to execute long exposures if all parts of the image are already overexposed at moderate exposure times. The fact that the possibility exists in principle, also independently of the use of color filters and/or neutral density filters which can be inserted into the beam path, to always record complete exposure series, without recording the presently captured brightness values, is mentioned as a possibility—although it is significantly less preferred.

A measurement using nine primary colors can already be performed using a conventional Bayer sensor while employing an additional neutral filter by alternatively inserting two broadband spectral filters to replace a neutral filter. This has obvious advantages due to the expansion thus possible of the accessible color space.

However, a neutral density filter can also be used as the light filter. This enables even particularly bright objects to still be correctly captured and/or measured. In particular, it is possible to correctly capture objects which luminesce so brightly that an overflow of the image sensor chips or individual image sensor chips is still a concern even at the shortest possible exposure time. It is to be noted that the movement of the light filters, whether neutral density filters and/or color filters, into the objective beam path is performed controlled by the camera in a preferred exemplary embodiment. In particular in the case of the neutral density filters, the brightness values obtained using the image sensor chips (i.e., the brightnesses in the individual color channels) can be observed for the control. A particularly rapid measurement results when it is decided image sensor by image sensor whether in each case a further exposure with longer or shorter exposure duration is required. For this purpose, in a preferred variant, the maximum values which are obtained using a chip or the minimum values of the brightness can be observed. If individual brightness values are outside the range in which a sufficiently linear behavior can be assumed or sufficiently low noise can be expected, a further measurement with shorter or longer exposure time can be provided for the entire image sensor chip; in addition, if a plurality of image sensor pixels of a chip have also experienced a quite large or quite small exposure, a correspondingly corrected recording of further data can be performed with longer or shorter exposure time and/or with inserted neutral density filter. It is to be noted that possibly multiple different neutral density filters would be usable. This can further expand the accessible dynamic range.

It can also be studied to establish required exposures whether an overexposure or an underexposure of individual image sensor chip pixels was observed in the region which has an overlap with image sensor chips of the other group, or whether it has occurred in a region which is located in a gap of the other image sensor chip group. Depending thereon, it can then be decided whether another exposure can also be triggered if necessary at the image sensor chips which overlap with the overexposed or underexposed image sensor chip. The restriction of the measurement having longer or shorter exposure duration to only one respective chip or a few chips enables the overall of measurements required in one camera rotational position to be shortened and therefore the measurement to be accelerated overall. However, it is obvious that at latest, when a neutral density filter is inserted into the beam path, a measurement using all chips will preferably be performed. It is to be noted that neutral density filters are readily available and sufficiently homogeneous in the size typically required for the present invention. Where a calibration using an internal reference light source is performed, it can be advantageous to observe the reference light source both attenuated by the neutral density filter and also not attenuated, if there is doubt about the continuous resistance or homogeneity of the neutral density filter.

If a filter is moved into the beam path to replace another light filter, in particular a non-attenuating filter element can be used as one of the other or the single other filter, which has identical or at least essentially identical refraction properties and was also calculated into the beam path. In this manner, an offset or the like with and without light filter is prevented from occurring due to the insertion of the light filter into the beam path, so that the imaging properties of the objective are not changed and in particular the association between image pixels and spatial angle is also uninfluenced by the respective filter.

It is particularly advantageous if the camera has the option of fully automatic self-calibration. For this purpose, on the one hand, a dimming means can be provided, such as a mechanical, highly light-tight shutter. Using this it is possible to determine the dark behavior of all image sensor chip pixels exactly. At the same time, it is particularly preferable if a reference light source which is constant for at least a short time is provided, using which the image sensor chips is possible in particular with dimmed, i.e., closed mechanical shutter. In particular, an LED can be used, which is either operated using stabilized current or is stabilized by simultaneous irradiation of a part of the light emitted thereby onto a large-area sensor. Using such a reference light source, it is possible to determine the exact brightness which is captured using individual image sensor chip pixels exactly as a function of a set gain (amplification) and/or an analog offset. This can be the case, if desired, with different illumination durations, for which either an electronic shutter is used or the illumination is briefly turned on and off. Measurement can then be performed at different set gain values. The reference light source only has to be stable for the duration of a calibration measurement, so that the influence of amplification or analog offset can be determined. This development may be readily technically implemented comparatively simply. If desired, the reference light source can also be regularly compared to an absolutely (officially) calibrated light source.

If a reference light source is provided, the analysis unit will typically be designed for the exact determination of the pixel sensitivity. It is apparent that in this manner a high linearity can be achieved, which is particularly advantageous if extremely large dynamic ranges are desired. This is because the large dynamic range enables brightness values to be changed after the capture under specific conditions. In other words, an entire scene can be “calculated” brighter or darker. If this is done, alinearities could have particularly massive effects.

The camera will preferably have a sequence controller which also determines whether further measurements are required in a given position or whether further measurements can be performed at another camera position. It is therefore advantageous if the sequence controller not only specifies the recording sequence at one point, but rather also determines when the camera can and/or should be moved further and then if necessary causes the drive pulse generation or release. The recording of HDR sequences is preferably performed in this case by changing the exposure times. If electronic shutters are used, very short exposure times can also be implemented without great expenditure. This is advantageous if extremely bright objects are to be captured with correct brightnesses, for example, the sun in a clear sky. At the same time, a measurement of very low brightness values can also be performed with greater accuracy by integration over a sufficiently long time. For an HDR sequence, no changes of the amplification are thus preferably performed; the change exclusively over the exposure duration or the possibly performed insertion of a neutral density filter has the advantage that exposure times can be determined very accurately by counting a cycle and in this regard deviations between two measurements are determined essentially only by the influence of the cycle stability, which can readily be neglected in typical applications.

It is considered to be advantageous if measuring can be performed using an image sensor chip so that a respective pixel is in a moderate range of the dynamic range accessible at a given exposure time and a given amplification. With very low brightness values, these values are influenced excessively strongly by noise and a given offset, which is possibly not completely compensated, i.e., dark currents or counting rates have excessively strong effects.

Although measurements are preferably always executed with subtraction of the measured values obtained at a pixel in darkness, errors can nonetheless occur, for example, if the camera is subjected to strong temperature variations or the like between dark measurement and actual measurement. Furthermore, it is advantageous if the brightness value determined using a given image sensor chip pixel is not excessively large. Otherwise, for example, saturation effects can begin, which have effects stronger than desired. In the case of a typical 12-bit dynamic response, values at which at least the third-smallest bit responds and at most the tenth-largest bit responds can be considered as the moderate dynamic range. This is particularly advantageous during an HDR measuring sequence, because then there is a sufficiently broad bit overlap to the next brighter or next darker image of the sequence. This is multiplied by the brightness variability given with typical scenes, i.e., it will be the case in very many pixels of a respective image sensor chip.

On the one hand, it can be monitored here whether the brightness values captured using greater and lesser exposure at least approximately correspond to the expectations; averaging can be performed, etc. If equal and substantial deviations between images of an image sequence occur for specific image sensor chip pixels or pixel blocks, this can suggest turning on or off light sources. In such a case, either a warning can be output if necessary and/or a measurement or image recording can be repeated as a whole.

While it was explained above that the response of the third to tenth dynamic bits of a total of 12 bits are located in the moderate range for a dynamic range, it is apparent that the invention is neither restricted to image sensors having a dynamic response of 12 bits nor does a moderate dynamic range have to be as small as only 8 bits of at most 12 possible dynamic bits. However, it has been shown that cost-effective image sensor chips also permit a dynamic range of typically 10-12 bits of nominal dynamic response on the application date (although linearity deviations are then possibly already substantial, as can occur due to noise, for example).

It can be considered to be critical in a sequence if pixel values are located very broadly in the lower range of the dynamic range accessible using a single exposure at given amplification (gain) and given exposure time, for example, because only two of 12 bits respond, or because individual bits have captured extremely bright light sources and are in or nearly in saturation, for example, no more than 2 bits below the overflow threshold. In such a case, a further measurement can already be initiated by the sequence controller upon response of individual pixels or a few pixels. In addition, it can additionally and/or alternatively be provided that further measurements are performed when a substantial proportion of the pixels, for example, more than 3% or more than 10% of an image sensor chip or of the relevant area thereof is close to a low exposure threshold, for example, response of only at most 4 bits of the dynamic range and/or a high exposure threshold, i.e., values of greater than, for example, 9 bits of 12 possible bits of dynamic response.

It is obvious that a pixel-by-pixel observation of exceeding limiting values can be performed for this purpose, but to determine whether further exposures are required for an HDR sequence according to these guidelines, no more than, for example, four counters (if necessary for each image sensor chip, if further exposures are decided on by image sensor chip) have to be provided, using which it is counted how many pixels are respectively above or below the limiting threshold. By comparing the counted number of pixel values to a number considered to be acceptable, a decision can also be made about the execution of a further measuring sequence.

It is also to be noted that specific pixels can remain unconsidered in the consideration of whether a further exposure is required at a given camera position. This can be the case, for example, if, during a measurement of dark values, a measured value which is significantly too high is obtained with such a pixel and/or if upon exposure using the reference light source and possibly variations of the amplification or the analog offset and/or the exposure duration using reference light, a behavior is observed which deviates significantly from an expected behavior. In such a case, it can be presumed that the pixel is not suitable for determining correct brightness values. The brightness values expected at its position can then moreover be interpolated as necessary during the determination of an HDR data set or the like. Because the presence of defective pixels on the image sensor chips is readily permitted, image sensor chips of lower selection level can be used; this readily further reduces the costs of the camera arrangement. To determine which pixels are suppressed, a lookup table or the like can be used.

Furthermore, it is to be noted that depending on the degree of the overlap between multiple image sensor chip groups in the various partial beam paths, some pixels classified as defective can also be located in an overlap region. In such a case, interpolation is not even necessary; rather, it is possible, in order to consider pixel defects, to make use of those pixels which are possibly located on the respective other image sensor chip, using which a specific, redundantly captured scene region is observed.

It is also to be noted that pixels can possibly also be recognized as defective without reference to the reference light source or the like, for example, if identical values always result notwithstanding the respective rotational position thereof, even if adjacent values vary strongly. This causes pixel defects to at least appear probable. Suppression or non-consideration can also be provided here.

In order that pixels possibly remain out of consideration, statistical items of information such as mean values and standard deviations can accordingly be determined for each pixel.

It is to be understood from the above statements that protection is claimed in particular for a camera having a fixed objective, a beam splitter which splits objective beams into two partial beam paths, and two groups of preferably color-sensitive surface sensors, wherein the planar sensors of the first group are spaced apart with gaps and are arranged in the first partial beam path and the planar sensors of the second group are arranged in the second partial beam path overlapping the gaps of the first, and wherein the camera is capable of being rotated further about the nodal point to measure or record full spheres and in this case to exactly capture the rotational end position assumed, preferably without creep, at the end of the further rotation and to measure an HDR sequence before further movement, in particular with a dynamic response of the total of greater than 30 bits using surface sensors having a single recording dynamic response of less than 16 bits, preferably not greater than 14 bits, in particular preferably not greater than 12 bits.

It is noted as clear and comprehensible that the invention, although protection is claimed in particular for such a camera, is in no way restricted to such a camera, but that such a camera offers special advantages, in particular because measurement can be performed by the planar sensors rapidly, cost-effectively, with extremely high dynamic response, and with outstanding position resolution. It is assessed that using such a camera, while employing mass-produced image sensor chips available cost-effectively on the application date, full-spherical images having greater than 30 bits dynamic response of a resolution of greater than 800 megapixels per full sphere can be recorded within less than 1 minute.

It is to be noted that it enables the measurement with extremely high dynamic response, also to compensate for the effect of, for example, multiple back reflections, i.e., because light away from the image sensor surface comes back to the interfaces closer to the objective entry and this light again reaches the sensor. This can be performed, for example, by measuring the so-called point spread function in a previous measurement, which is preferably carried out specifically using each individual camera. With known point spread function, a corresponding correction can then be performed. Because the effects of the back reflection are already significantly reduced in any case as a result of the use of a solid beam splitter, the images obtained with the compensation are hardly still influenced by such effects. It is apparent from the above statements that it is preferable, but not required to use a means to compensate for internal back reflections. In a preferred variant, this means can comprise a memory for a point spread function, which is specific for a camera or camera model, i.e., averages over typical properties of a camera model, or point spread function compensations and an image data changing unit, using which recorded image data, in particular HDR image data having a dynamic range greater than 20 bits, preferably greater than 30 bits, can be changed or supplemented to compensate for back reflection with use of the point spread function or point spread function compensations stored in the memory. These correction means can cause an in-camera correction of the point spread function; in such a case, they comprise a data memory for the data describing the point spread function and a computer means, to cause, based on the data describing the point spread function, as are stored in the data memory, the correction of recorded images. Alternatively, it is possible to store data relevant for the correction or partial correction only with the image data on an image data memory or to provide them in another manner for off-line image processing.

### BRIEF DESCRIPTION OF THE DRAWINGS

The invention will be described solely by way of example hereafter on the basis of the drawings.

For a more complete understanding of the present invention, and the advantages thereof, reference is now made to the following descriptions taken in conjunction with the accompanying drawings, in which:

FIG. 1 shows a camera arrangement of the present invention in cross section, specifically in the viewing direction along the rotational axis, about which the camera housing is rotated in operation;

FIG. 2 shows an illustration of an exoskeleton for a camera arrangement according to FIG. 1;

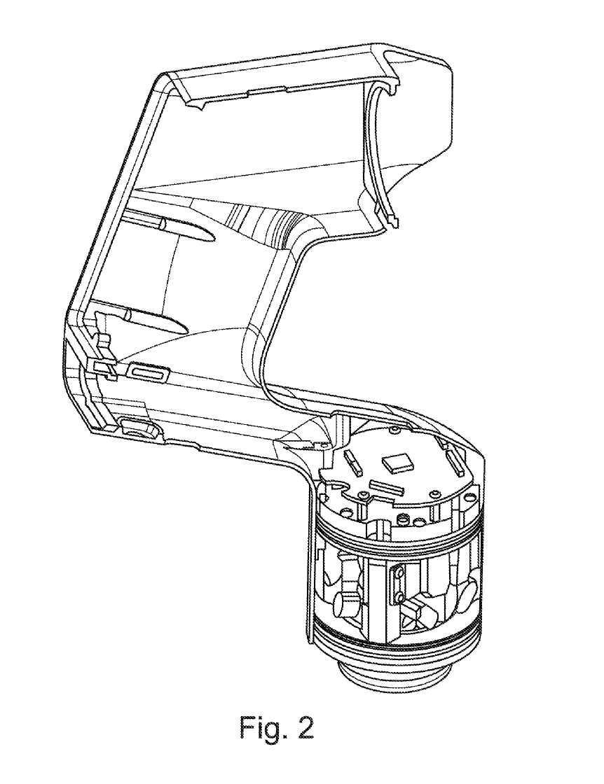

FIG. 3 shows a further cross section through the camera arrangement of the present invention from FIG. 1, but perpendicularly to the optical axis here; the second image sensor printed circuit board, which is arranged on the beam splitter, is only shown in FIG. 4;

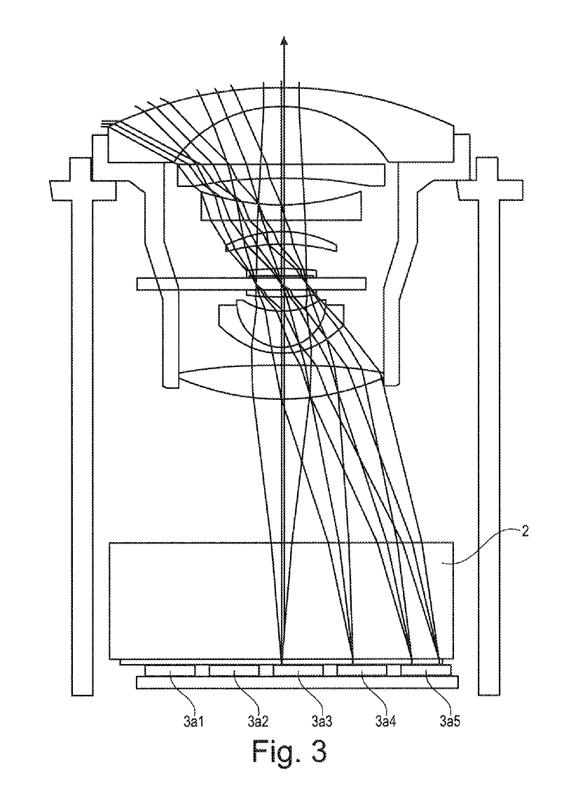

FIG. 4 shows an illustration of the location of the image sensor chips on the printed circuit boards in different partial beam paths of the camera arrangement, shown on a part of the view of FIG. 3 (moreover rotated by 90°), in order to illustrate the location of the image sensor chips in relation to one another on the first and second beam splitter surfaces; the regions of the gaps in one image sensor chip row are transferred shaded to the other image sensor chip row;

FIG. 5 shows an illustration of the dynamic range resulting with different exposure times and inserted dynamic filter; and

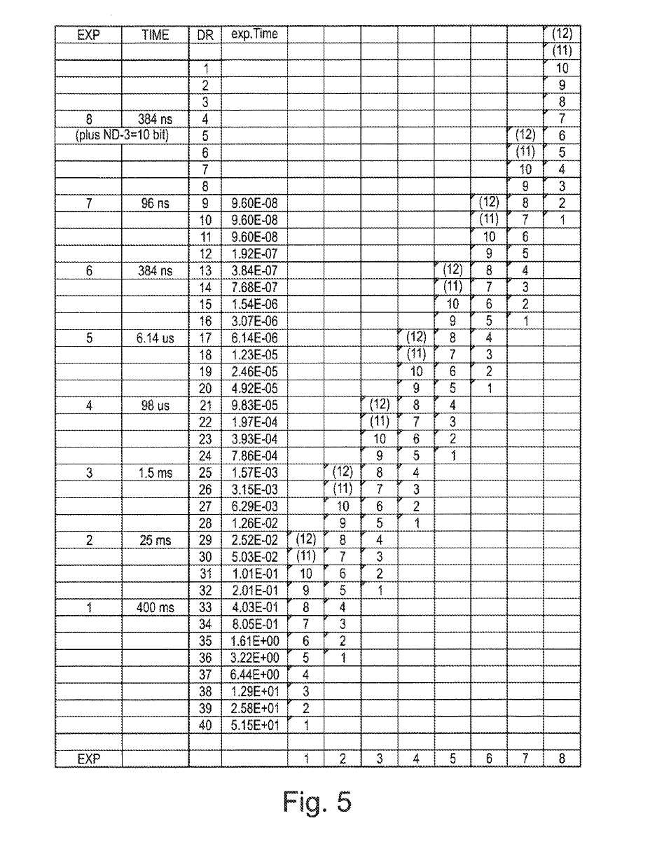

FIG. 6 shows a sectional view through an exoskeleton as shown in FIG. 2 with essential modules of the camera arrangement.

### DETAILED DESCRIPTION OF ILLUSTRATIVE EMBODIMENTS

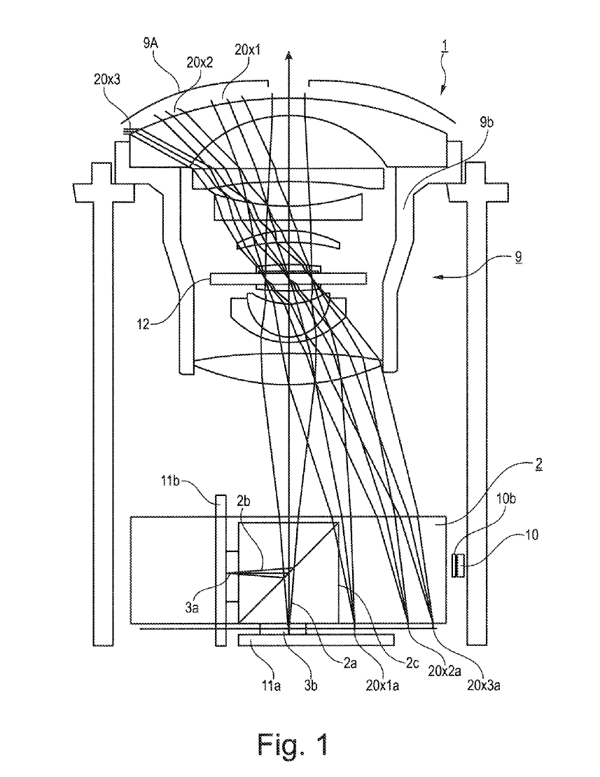

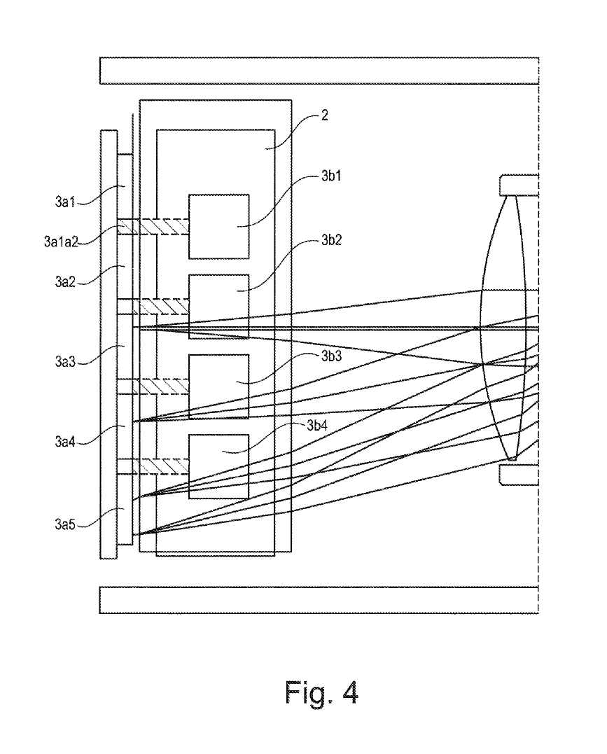

According to FIG. 1, a camera arrangement identified generally with 1 comprises a beam splitter arrangement 2 and a plurality of planar image sensor chips 3a and 3b arranged in the partial beam paths thereof, wherein multiple image sensor chips arranged with gaps in relation to one another are arranged in a first partial beam path 2a, cf. image sensor chips 3a1 to 305 in FIG. 4, and wherein a gap-overlapping image sensor chip 3b1 is provided in a further partial beam path 2b of the beam splitter for at least one gap 3a1a2.

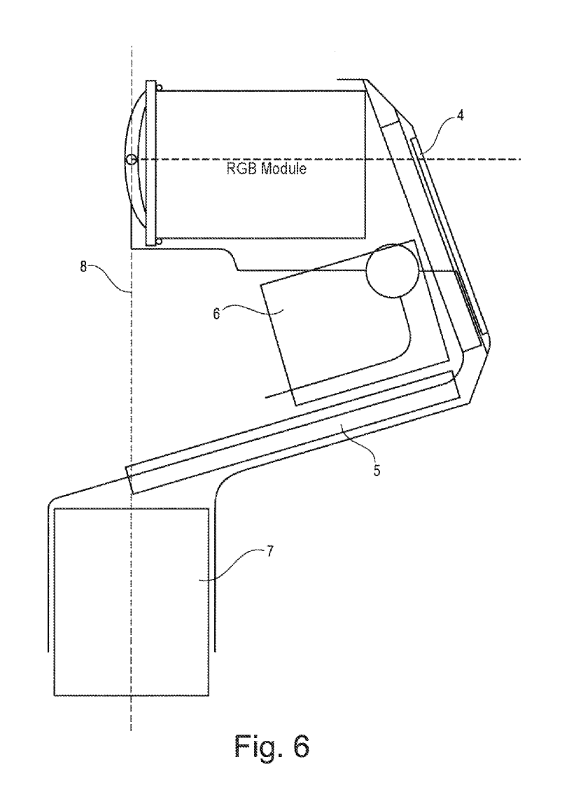

The camera arrangement is provided in the present case with a wide-angle objective 9 and is formed as an autonomous camera body permanently provided with operating elements, cf. reference number 4 in FIG. 6, which has a data analysis and memory unit 5 and a rechargeable battery 6, and which is rotatable, upon mounting of the camera base body on a tripod (not shown), by a drive 7 about an axis 8, which is vertical during use, wherein the optical axis 8 extends through the nodal point of the wide-angle camera objective.

The camera objective 9 is considered in the present case as a fixed focal length objective having a sufficiently large opening angle that an opening angle of 180° is obtained in the vertical direction. The camera objective is rotationally symmetrical about its optical axis, although the camera is rotated for the purposes of recording full-spherical images and only a strip-shaped image is recorded in each rotational position. The use of a rotationally-symmetrical objective is preferable in this case, because the corresponding optical elements are more cost-effective. It is equally possible to trim individual or all lenses in the equatorial direction to reduce the dimensions of the sensor head. To reduce scattered light effects and the like, an aperture which defines a vertically extending slot is placed upstream of the objective, cf. 9A, so that beams which otherwise enter laterally cannot reach the camera interior, which is advantageous because otherwise scattered light is to be expected to a substantial extent, as can be seen by the exemplary illustrated beams 20x1, 20x2, 20x3 (which are suppressed by the slot and do not enter the camera interior), and which do not end at image sensor chips, cf. 20x1a, 20x2a, 20x3a.

It is apparent that the individual optical elements of the objective 9 are arranged in a suitable holder 9b, which is stable for a sufficiently long time, is insensitive to shocks as required, and is only slightly sensitive to varying temperatures. It is to be noted that the holder 9b is only schematically indicated, which is already apparent because no connection to the objective holder is recognizable for some of the lenses associated with the objective. However, it is to be noted that the front lens has a flattened edge region toward the camera interior, using which it rests on a step which is formed in the objective holder. As will be described hereafter, this makes the mounting of the lens easier, because it only has to be centered here. It is apparent that this principle of arranging a flat lens edge surface on a step provided on the objective holder is advantageously used if possible.

The individual lenses of the objective are highly tempered, but only to a dynamic response of 12 bits. Within the objective, an aperture arrangement is provided for limiting edge beams, and also a mechanical shutter, which is electrically operable under control of an electrical control unit associated with the camera controller 5 (sequence controller), by which incident light in the interior of the camera body can be completely suppressed. It is to be noted that the aperture arrangement can comprise more than one aperture.

It is to be noted in this context that the camera housing is designed so that no light also penetrates into the interior of the camera housing through other openings, for example, electrical bushings for contacting the controller, the battery, and the data interfaces, and/or from the operating unit and the associated display screen 4. Therefore, absolute darkness prevails in the camera housing upon closing of the mechanical shutter, if an LED 10, which is also arranged in the camera, is not excited to radiate the light onto a reference sensor, on the one hand, and, via a light scattering disk 10b, onto a surface 2c of the beam splitter 2 on the other hand, from which a first part of the calibration light is incident on the image sensor chips 3a1-3a5 of the first group, while a second proportion of the light is incident on the image sensor chips 3b1 to 3b4 in the second partial beam path. It is ensured by the light-balancing scattering disk 10b in this case that a proportion of light which is uniform and remains uniform is scattered to a sufficient extent onto each pixel of the image sensor chip.

The image sensor chips 3a and 3b are each soldered onto a printed circuit board, i.e., all image sensors 3a1-3a5 of the group 3a are arranged on a first, shared printed circuit board and all image sensor chips 3b1-3b4 of the second group are fastened on another printed circuit board. It is to be noted here that it is possible—notwithstanding the illustration in FIG. 4—to arrange an equal number of image sensors on each printed circuit board. In this manner, structurally equivalent printed circuit boards can be used for both partial beam paths.

This printed circuit board is yielding and, in addition to the image sensor chips, also carries the control electronics and the interfaces to the analysis electronics, shown in FIG. 1 as FPGA boards 11a and 11b. The FPGA boards 11a and 11b are equipped, as will be described hereafter, with such high-performance FPGAs that it can be studied in real time whether individual pixels of the image sensor chips behave normally, whether the brightness values captured thereby exceed specific maximum values or fall below minimum values, and whether an excessively large number of pixels per image sensor chip exceeds or falls below specific brightness values.

The data receptacle and controller 5 is designed to store a plurality of full-spherical recordings of high dynamic response and high resolution within the camera housing, so that the data only has to be retrieved at the end of a workday; suitable interfaces are provided for this purpose. The battery 6 is also designed to record a plurality of full-spherical images, without having to be changed or recharged.

In the present exemplary embodiment, the beam splitter block is an elongated, solid beam splitter block made of two prisms, which are cemented to one another, wherein the image sensor chips of the first group are applied to the exit surface of the first prism and the image sensor chips of the second group are applied to the exit surface of the second prism, which defines the second partial beam path. Both the image sensor chips of the first image sensor chip group and also the image sensor chips of the second image sensor chip group are adhesively bonded in this case to the respective surfaces using an optical adhesive, which is UV-curing. The thickness of the adhesive layer can vary slightly if the sensors are adhesively bonded in optimized positions, in particular under machine control, as will be explained hereafter. The objective is similarly designed so that for the calculation thereof, both the beam splitter block and also the layers of the optical adhesive are also incorporated according to the mean expected or projected layer thickness. It is to be noted that with corresponding adhesive bonding of the sensors to the beam splitter block and a fixed objective, particularly high levels of sharpness are achievable, because this enables the sensor chips to be arranged according to the exact tolerances of a very specific individual optical unit.

Furthermore, a filter element 12 is incorporated into the design of the objective, which is arranged so it is replaceable with a further filter element (not shown), specifically by automatic replacement with movement of a suitable actuator by the controller 5.

The drive 7 is constructed in the present case as a piezo-rotational drive, which is capable of reaching a rotational position very rapidly and thereafter, i.e., after ending its excitation, remaining without creep in its end position. In the present case, a drive is considered to be creep-free which, within the time required for carrying out an HDR measuring sequence, thus typically in such a practical variant for 0.5 seconds to 1 second, executes at most a movement in or opposite to the drive direction of less than 1 pixel; the creep movement is typically between 1/10 to ¼ pixel during the measuring duration, even if the camera does not stand exactly vertically.

The control of the rotational drive is performed by the controller 5. The controller 5 also receives signals about the rotational position in which the camera was placed without creep in each case by the drive 7, and does so from a high-resolution angle encoder. High resolution in this case means with subpixel accuracy corresponding to the pixel size of the respective image sensors.

It is to be noted in this regard that in a first implementation of the invention, image sensors having a resolution of 2592×1944 active pixels of the size of approximately 2 μm×2 μm and an upstream RGB Bayer filter were used, the image data of which can be read out and digitized using a 12-bit ADC on chip, wherein the total single-chip area occupies a breadth of 5.7 mm×4.3 mm. The image sensor chips used in this first constructed variant of a camera arrangement according to the invention additionally have an electronic rolling shutter (ERS). The chips used are adjustable in particular with respect to the analog amplification and the analog offset of the pixel output signals before the analog-digital converter. It is assessed that such image sensor chips are readily available cost-effectively and in large quantities.

The camera is mounted and used as follows:

A first type of mounting is as follows:

Firstly, a preliminary mounting of components is performed. In this case, for example, the optical elements of the objective, which are to be mounted in the objective holder 9b, are fixed therein with high precision, so that a prefinished unit is obtained, which still has to be arranged in relation to the rotational axis of the exoskeleton and in relation to the beam splitter block in the exoskeleton, however, and in relation to which the sensors are to be correctly mounted. A finished mounted objective is thus not provided insofar as this beam splitter block is considered to be part of the objective, as a result of the consideration of the beam splitter block in the objective design, but rather only a prefinished component of the objective.

Furthermore, the printed circuit boards, for example, the FPGA printed circuit boards for analyzing the image sensor chip signals, the printed circuit boards having the calibration LED and the associated reference sensor and also the scattering disk, which sufficiently balances light in each case over at least an 8×8 pixel-sized area, are pre-mounted, function checked as necessary, and then arranged at the provided points in the exoskeleton, and connected to one another, insofar as already possible. This also applies to the remaining modules, insofar as they are already pre-mounted, for example, the rotational drive module.

Printed circuit boards are then also equipped with the image sensor chips and individually checked for perfect function. As noted, yielding printed circuit boards and, for the connection between image sensor chips and printed circuit boards, a comparatively soft solder are used for this purpose, so that in the finished mounted state, in which the image sensor chips are adhesively bonded using UV-cured lacquer onto the respective beam exit surfaces of the beam splitter block, possibly acting forces can be absorbed by the solder and/or the printed circuit board, without the adhesive detaching or other impairments, for example, contact failures, being expected. A high long-term stability is thus provided. This obviously has an effect in any form of receptacle, for example, because transport, thermal effects, etc. interfere less strongly. The high long-term stability is also advantageous, however, where very small pixel areas are provided and at the same time high accelerations act on the sensors, for example, during the rotation of a camera. The design of panoramic cameras having rotational drive, in particular having piezo drive, is facilitated in particular by the cementing.

After preliminary mounting of the modules in the exoskeleton, it then has to be ensured that the objective holder having the pre-mounted elements is mounted and fixed correctly aligned in relation to the beam splitter block and the image sensor chips on the printed circuit boards. At the same time, it has to be ensured that the optical nodal point of the objective comes to rest correctly on the rotational axis of the camera housing.

This can be carried out in that the exoskeleton with the pre-mounted elements is mounted on a suitable optical bench, register marks, which are arranged at points known in relation to the mounting point, are observed using the arrangement, which is already functionally capable in this regard, and it is then determined from the data captured in this case, for example, how the objective holder has to be mounted in relation to the exoskeleton to ensure a correct alignment of the nodal point; after correct positioning of the objective holder, which can be carried out fully automatically in particular using a robot arm or the like, the objective holder is fixed. For this purpose, UV-curing lacquer can be applied beforehand to the interface between objective holder and exoskeleton, if it can be well illuminated, and then a UV light source can be activated for curing. Where such surfaces between objective holder and exoskeleton cannot be well illuminated, it is alternatively possible that temperature-induced curing or the like is performed. It is preferable, but not required in this case to be able to trigger the curing intentionally at a specific time. Where this does not have to be the case, a self-curing adhesive having suitable time until the curing can also be used.

After fixing of the objective holder, the beam splitter block and the printed circuit boards having the image sensor chips are then also to be mounted. This can again be performed by observing register marks and while employing robot arms, which are controlled in response to the images which are recorded using the image sensor chips, to move the image sensor chip printed circuit boards as required. As soon as a correct alignment of the elements has been achieved, the image sensor chips are fixed accordingly, wherein a UV-curable lacquer is usable in any case here due to the possibility of radiating UV light in through the front lens.

In principle, there are multiple options for carrying out the adhesive bonding. Either all image sensor chips which are pre-mounted on a printed circuit board can be adhesively bonded simultaneously on the beam splitter block, without the present location of the chips on the printed circuit board being considered; the locations and alignments on the printed circuit board, which will change slightly from image sensor chip to image sensor chip, will then have effects such that an interpolation possibly will have to be performed for a raw data set, to associate the real image sensor chips, which are located randomly but fixedly and therefore in a known manner, with pixels on a defined grid. This may be managed per se using known methods, because the corresponding interpolation methods each only have to be carried out image sensor chip by image sensor chip. It is possible to associate a measurement file with the camera, which was produced by analyzing marks (such as register marks) arranged at known points in relation to the camera and with the employment of which the stochastic image sensor alignment can be compensated for. Alternatively, it is possible to utilize the flexibility, which is present, although it is slight, of soldered bond and printed circuit board base material to align each image sensor chip exactly with pixel accuracy while analyzing the instantaneous image data just captured during mounting, so that all pixels are located on a shared grid from the beginning. Because edge pixels can be ignored if necessary, it is only important whether an accuracy of less than one pixel dimension can be maintained during the adhesive bonding for each pixel. This requires, on the one hand, being able to perform positioning using a robot arm of greater accuracy than 1-2 μm—which is possible per se—and, on the other hand, being able to move a chip which is not yet adhesively bonded, but rather is only pre-mounted (soldered) on its printed circuit board after adhesive bonding of other chips—together with the printed circuit board—far enough to align it correctly, which is possible due to the typical flexibility of printed circuit boards and yielding of soft solder, however. If this is performed, a raw data set calculation is substantially simplified, because in any case the correct column and row still has to be selected, but numeric rotational corrections can be omitted.

According to a further mounting variant, the camera is mounted and used with respect to objective and beam splitter block mounting as follows:

A preliminary mounting of components is again performed first, specifically firstly the objective components in relation to one another, before the image sensor components are mounted in relation to the objective components. For this purpose, in this variant a separate module is formed, using which objective components and sensor components are then inserted jointly into the exoskeleton of the camera; during this insertion of objective components and sensor components, which are finished pre-mounted with one another, they are inserted in relation to the exoskeleton so that the rotational axis defined by the exoskeleton and the camera rotational drive located therein is perpendicular to the optical axis of the objective if possible, specifically at the point provided for this purpose, which is referred to in the present application as the nodal point for reasons of better memorability.

During the preliminary mounting of the objective, for the purposes of a panoramic camera which captures wide-angle images, the fact can be utilized that the objective does not have to be focused, but rather is set fixedly. All lenses of the objective can thus be fixedly adhesively bonded in a fixed objective holder. It is possible and preferable to design the lenses of the objective so that they have a flat support surface toward the sensor. The lens holder in the objective will then be formed in the ideal case from a single material piece having multiple steps, wherein a separate step is provided for each of the lenses. The lens mounting then only requires centering, which may be carried out easily.

The objective holder can either be part of the separate module, using which objective components and sensor components are then jointly inserted into the exoskeleton of the camera, or the objective holder is inserted after lens mounting into the objective. The image sensors and the beam splitter block are then to be mounted.

A mounting can again be carried out—as already described above—such that firstly the image sensor chips are adhesively bonded to the beam splitter block. This is preferably carried out using a very solid, transparent adhesive, the optical properties of which are known and were taken into consideration during calculation of the beam path. In the mounting variant set forth here, in consideration of the fact that later in any case corrections on the images and a pixel-by-pixel association of pixels with real directions in space will still be required, an exactly aligned mounting is omitted and it is only ensured that the image sensors are arranged on the beam splitter block so that the gaps on one beam splitter block surface, i.e., the first partial beam path, are overlapped by the image sensors on the other beam splitter block, i.e., the other beam splitter block surface, and sufficient overlap at least still occurs toward the image edge that the desired strip width is obtained.

It is then to be ensured that the beam splitter block is fixed in the correct alignment in relation to the objective. The beam splitter block has six degrees of freedom per se in relation to the objective, which have to be selected correctly for optimum image reproduction. However, tolerances only have to be taken into consideration to a small extent during the mounting, because the manufacturing of the beam splitter block can be carried out quite accurately, the adhesive bonding of the image sensor chips is carried out with little variation, and the lenses of the objective are mounted fixedly in the objective holder. The variation of the beam splitter block adhesive bonding in the objective-beam splitter module required for optimum image reproduction can be achieved, inter alia, by a variation of the adhesive thickness.

To determine the ideal position of the beam splitter block adhesive bonding, the beam splitter block is moved using a numerically controlled (robot) arm to approximately the correct point in the objective-beam splitter module, an array of known marks is observed through the objective using the image sensor chips already adhesively bonded on the beam splitter block, and then the beam splitter block is moved by means of the arm until an image of the known marks, which is recognized as optimally sharp, is obtained using the image sensor chips. The adhesive bonding is then performed in this position. This can moreover be carried out by UV activation of a UV-curing adhesive which has already been previously applied.

It is to be noted that moreover the scattering disks for reference light etc. are also mounted at suitable points and at the given time.

The image sensor chips then have a fixed arrangement in relation to the objective. Therefore, it can be determined per se for each pixel from which direction in relation to the objective light is received. To ensure this determination, in the variant described here, a known pattern is observed, which is applied in a known direction in relation to the objective (for example, an accurately measured pattern made of register marks). Therefore, it can then be determined, possibly by interpolation, for each pixel from which direction in relation to the objective it receives light. This is carried out first.

After this step, the module made of objective, image sensor chips, and beam splitter is to be inserted into the exoskeleton and in turn fixed therein; it is to be noted that the read-out printed circuit boards for the image sensor chips, etc. can also be associated, if necessary, with this module. Specifically, it is preferable in any case to design the module made of objective, image sensor chips, and beam splitter so that images can be read out sufficiently simply for the mounting and alignment.

This can again be performed, for example, by adhesive bonding, wherein now the objective is fixed in the exoskeleton of the camera so that the least possible parallax error results. This can be carried out by rotation of the camera about the rotational axis with observation of the resulting deviations in specific directions. It is apparent that the minimization of the parallax errors is desired, but is not achieved in its entirety. A relationship between the direction in space on which the objective is actually oriented and the direction in space which one would expect with ideal location of the objective results by way of measurement. Together with data which indicate which pixel receives light through the objective from which direction, it therefore becomes possible to associate a specific direction in the real space with each pixel.

Thus, after suitable measuring and calibration processes, a unique determination of spatial directions can be performed, which contributes to being able to record measurable full-spherical images using the camera arrangement, presuming sufficient spatial resolution, which in turn opens up a plurality of applications of measuring technology. In particular, it is readily possible to perform a reconciliation of a full-spherical data set with the data of a laser scanner, etc., for example. It is similarly to be noted that this exact association is more significant for certain applications than for other ones. Thus, for example, for measuring purposes in the case of the documentation of building construction progress or in the case of the capture of crime scenes, a higher accuracy can be required than in the case of light field recordings, which are required for the digital image processing and generation. There are thus certainly applications where the accurate measurement, calibration, etc. are not necessary. A brightness calibration can then furthermore be carried out.

One possibility for preparing the camera for high-accuracy measurements and/or for completing the camera mounting is thus as follows:

After completed correct alignment of the image sensor chip printed circuit boards in relation to one another and the objective, one begins to calibrate the camera and measure the optical properties.

For this purpose, firstly register marks attached at known positions are observed. This enables a relationship to be established between directions of real-world coordinates and the image pixels, on which imaging is performed from the corresponding direction thereof. It is to be understood that different associations of individual pixels with spatial directions can exist due to slight offset and/or slight twisting from camera to camera. Against this background, it is apparent that the data thus acquired are preferably recorded specifically by camera and then enable a clear association of image sensor pixels with spatial angles to be performed.

Thus, after suitable measuring and calibration processes, a unique determination of spatial directions can be performed, which contributes to being able to record measurable full-spherical images using the camera arrangement, presuming sufficient spatial resolution, which in turn opens up a plurality of applications of measuring technology. In particular, it is readily possible to perform a reconciliation of a full-spherical data set with the data of a laser scanner, etc., for example. It is similarly to be noted that this exact association is more significant for certain applications than for other ones. Thus, for example, for measuring purposes in the case of the documentation of building construction progress or in the case of the capture of crime scenes, a higher accuracy can be required than in the case of light field recordings, which are required for digital image processing and generation. There are thus certainly applications where the accurate measurement, calibration, etc. are not necessary.

A brightness calibration can then furthermore be carried out.

By using an officially calibrated external radiation source such as an integrating sphere or the like, an absolute brightness sensitivity can be determined in this case for each pixel with official calibration. A reconciliation with the internal reference light source, which has short-term stability, is preferably also performed in this case, so that, on the one hand, due to regular reference to the internal reference light source, unevenly sensitive pixels no longer have an effect and, on the other hand, the measured values resulting using specific pixels or pixel groups upon use of the reference light source are reconciled exactly to an absolute brightness. It is obvious that the external source can regularly itself be officially checked and, if a user desires it, a regular recalibration of the camera can also be performed by comparison to the reference light source.

The internal brightness calibration is preferably performed first. This is carried out as follows:

Firstly, the mechanical shutter is closed and therefore a measurement is enabled using the image sensor chips in absolute darkness. In this case, zero count values are not determined, but rather pixel count values, which will be different from zero and will additionally vary from pixel to pixel. The reason is that, on the one hand, the pixels are subject to noise, i.e., count values different from zero are observed as a result of solely statistical effects; the corresponding noise component can be significantly reduced by a longer observation time, as is known per se. On the other hand, the values are different from zero because the electrical signals obtained using the image sensor pixels are digitized by means of an analog-digital converter and an analog offset occurring at the input thereof depending on the pixel results in count values different from zero (the term count value is used here for the output signal from the ADC, because it is thus clear that reference is made to a digital value. Moreover, it is preferable to select an offset which results in a darkness mean value actually greater than zero and then to subtract it. This has proven to be advantageous and precise). In typical image sensor chips, this offset can be set or the offset can be compensated for. However, this offset compensation setting will not be 100% exact. In addition, for example, temperature-dependent variations, drifts, etc. are observed in practice. These result, after a specific time, in a count value different from zero again in spite of prior exact compensation. Therefore, it can be presumed that the measurements using the camera can also be executed under unfavorable conditions so rapidly that such effects have at most a marginal effect on a single measurement series under normal conditions.

The count value can then be determined for each pixel, which results at a given applicable amplification, i.e., which is set on the image sensor chips, of the analog electrical signals when the pixels are illuminated using the brightness of the internal radiation sources, while the mechanical shutter is still closed. With analog offset set exactly to zero and identical sensitivity of all image pixels for a given set gain, it would be expected that all image pixels would supply the same digital brightness values, at least insofar as the illumination is uniformly distributed spectrally, the color filters transmit equal brightnesses, and sufficiently uniform illumination of the entire surface by the light source is ensured. However, it has actually been shown in practice that differences occur from pixel to pixel. Insofar as sufficient balancing of the pixel illumination by the reference light source has been caused by means of the scattering disk, such variations of the brightness are exclusively to be attributed to image sensor pixels which are not uniformly sensitive. It is possible to correct for these varying sensitivities. For this purpose, on the one hand, the analog gain can be adjusted pixel by pixel, if this is possible; alternatively and/or additionally, a corresponding calibration file can also be generated, in that the instantaneous sensitivity is determined and stored for each pixel, so that by making use of the sensitivity values thus determined, a correction of the nonuniform pixel sensitivity is to be induced. (It is to be noted here that often a large amount of effort is required in any case during the raw image data processing; the use of a calibration file or the like thus does not represent a significant additional effort. It is possible and preferable in such a case to carry out the sensitivity setting of the pixels not only to balance the pixel sensitivities, but rather instead to optimize the signal-to-noise ratio).

It is to be noted that if necessary only approximately homogeneous illumination by means of the reference source, i.e., an illumination in which large-area variations are still to be observed, can be compensated for, for example, by interpolation, for example, spline interpolation over a specific field size, for example, 8×8 pixels; it is additionally possible to compensate for the light distribution, which is not completely homogeneous, by way of the scattered light disk associated with the internal calibration light source. For this purpose, for each pixel, a brightness value (already reduced by its dark value) can be determined upon illumination using the internal calibration light source for each pixel, on the one hand, and then the calibration light source in front of the objective can be observed.

Furthermore, it is apparent that the brightness values do not necessarily only have to be captured using a single exposure duration. Rather, it is possible to record the brightness values using an exposure series, wherein it is apparent that the signal components caused by light will increase with the exposure duration, while the analog offset will result in a constant signal level independently of the exposure duration. By determining corresponding compensation straight lines, the analog offset and the actual amplification can accordingly be ascertained from multiple measured values. For this purpose, the fact can be utilized in particular that the image sensor chips can be operated using electronic shutter with camera interior dimmed in relation to external light.

After determination of the dark count value, the offset, and the pixel sensitivity according to internal reference light source, the mechanical shutter can be opened and the calibration light source can be observed. During this observation, additional brightness values are recorded for each pixel, which result in a very specific, known brightness. The possibility thus results of converting a brightness value which is determined using a given pixel into an absolute brightness.

The measurement of the camera properties before beginning actual measurements can then still be continued; in this case, the so-called point compensation function or point spread function can be ascertained. As already stated, impairments can occur during the image recording due to undesired optical effects in the camera, such as scattering, reflection, etc. While per se a punctiform small light source, which only radiates light onto a single pixel, should also only generate a brightness value different from zero at this pixel, due to the undesired effects, a brightness value different from zero will actually be generated at a plurality of pixels, because scattered light, multiply reflected light, etc. is received there.

This effect also occurs per se in conventional cameras. However, back reflections, thanks to the typical measures for combating scattered light, combating back reflections, etc., such as blackening the housing interior parts, blackening objective interior parts, antireflective coatings of optical components such as image sensor chip protective glasses, lens surfaces, filter surfaces, etc. have an effect on the dynamic range achievable using conventional technologies of 12 to at most 14 bits (corresponding to aperture stops) such that the corresponding effects can then no longer be completely captured cleanly quantitatively; similarly, such effects contribute, for example, to a micro-contrast reduction. The camera arrangement of the present invention, in contrast, enables, on the one hand, as a result of the particularly preferred use as a highly dynamic camera having significantly more than 30 aperture stops of dynamic response during the image recording, typically between 36 and 40 aperture stops of dynamic response, the point spread function to be determined exactly and the undesired effects then to be compensated for very extensively in consideration of the determined functions. It is to be noted that the determinations of point spread functions and therefore also the numeric compensation thereof per se represent a well-defined problem which is readily solvable by those skilled in the art of optics, so that the exact mechanisms do not have to be described in greater detail here, but rather it can be stipulated for the purposes of the disclosure that a person skilled in the art is capable of performing the appropriate corrections as required from the washing function or spread function.

The point spread function can be determined thanks to the possible very high dynamic response, although in particular due to the beam splitter, the effects of the back reflection of light on the image sensor chip in the direction toward the objective entry lens and the back reception of multiply scattered light on other image sensor pixels are particularly weak.

It is apparent that a compensation of the point spread during the image recording is preferably carried out after an HDR sequence has been determined at one position. This can be carried out before storage of the raw data if the computing power of the camera arrangement is sufficient; otherwise, a corresponding compensation can also be carried out off-line.

After association of image sensors with spatial directions, the determination of the pixel uniformity over the entire area of the image sensor chip strip from a row of image sensor chips, the reconciliation between internal reference light source and absolute brightness, and if necessary the spread function, the camera can also be used for measuring purposes for high-precision measurements.

For this purpose, the camera is brought to the desired recording location, advantageously mounted with at least substantially vertical rotational axis, preferably exactly vertical rotational axis on a stable tripod, and a measurement is triggered by actuation on the input panel. It is to be noted that moreover auxiliary means can be provided to facilitate the exactly vertical alignment. Reference is made, for example, to multiaxial acceleration sensors, etc. It is also to be emphasized that deviations from an exactly vertical alignment are permissible per se, although such deviations are undesirable.

Thereafter, firstly a dark measurement is carried out with closed shutter, then brightness values are determined with closed shutter for multiple exposure times, the analog offset values and amplification(s) of respective pixels are determined therefrom pixel by pixel for the present temperature, camera power supply, etc., the shutter is opened, and the measurement is begun. In this case, the procedure begins with a moderate exposure duration and it is checked whether the captured measurement data require the recording of images in the same position with greater or lesser exposure duration. As will be clear from the above statements, for this purpose, on the one hand the brightness values are determined which were captured using the individual pixels of the respective image sensor chips and, on the other hand, statistical observations are undertaken about the overall brightness distribution. In the event of an excessive number of excessively bright pixels, an exposure having shorter exposure duration is carried out. If pixels are still excessively bright even with the shortest possible exposure duration, the controller excites the actuator, using which the neutral density filter having greater attenuation is moved into the beam path, and then carries out a measurement with suitable short exposure duration. Alternatively and/or additionally, it is checked whether, in the initial measurement of the sequence, pixels were excessively dark; if so, measurement is again performed using extended exposure times, it is checked again whether now pixels are exposed excessively dark, measurement is performed again, etc. This continues until it is ensured that the observation of the scene in the present rotational alignment of the camera is carried out without exceeding or falling below brightness limiting values.

A correct exposure series is therefore provided. The previously determined dark value is now to be subtracted from the exposures of each pixel, each pixel is to be compensated for the nonuniform pixel sensitivity, the interpolations are to be carried out at points of defective pixels, the exposure series for each pixel are to be combined, and the brightness values determined in one position on different image sensor chips are to be fused into a unified data set. In addition, further corrections such as debayering/demosaicing, etc., can be performed.

All of this can be performed off-line or, presuming corresponding computing power, as part of the data recording in real time.

The presently recorded data can then be joined to the previously recorded data. Because the exact rotational position at which the camera was stopped without creep for the recording of the present HDR sequence is known, it can be readily determined which pixels of each sensor in the circumferential direction enable the continuation of the previously stored data. It is to be noted that if necessary where the camera arrangement was not stopped with pixel accuracy, but very high accuracy is desired, an interpolation of the presently captured values can be performed on a fixed grid, as is known per se.

As soon as the data recording, the data processing, which has been performed in real-time as desired, and the storage of the data from one point has been completed, the rotational drive is moved further, approximately by the angle which is necessary so that an overlap of several tens of pixels remains to the previous image, preferably also approximately loft With lower-resolution image sensor chips, which have approximately 2200 pixels in the equatorial circumferential direction, full-spherical images can thus be recorded which have 50,000 pixels along the equator if 25 individual strips are recorded. With correspondingly many image sensors arranged in rows with one another having overlapping gaps, a total sphere resolution of 1 gigapixel therefore readily results.

The HDR sequences of 25 individual strips required for a gigapixel can be recorded with suitable drive and suitable internal data conditioning and processing within less than 1 minute using 38 aperture stops of dynamic response. In this case, the rotational angle encoder captures the end position in each case in which the camera is stopped without creep for the next measurement, with sub pixel accuracy, which readily enables linkage of the individual strips to form an overall image. It is obvious that the required corrections, for example, to nonuniform brightness, point spread functions, the determination of color values corresponding to the characteristics of the Bayer filter, etc. are also performed in the generated raw data images.

Furthermore, it is to be noted that the present application regularly refers to “brightness values”, even if the image sensor chips used are color chips, i.e., chips which can each differentiate each of multiple colors. The determination of a brightness value of a pixel thus means for example the determination of the brightness in a green channel or the determination of the brightness in a red channel or the determination of the brightness in the blue channel, without this being emphasized at each individual point at which reference is made to a “brightness”. Rather, the term “brightness” is used to take the circumstance into consideration that each image sensor chip will have multiple color channels; the term sensor uniformity can also if necessary correspondingly refer to the uniformity of the green-sensitive pixels in relation to other green-sensitive pixels, the red-sensitive pixels in relation to other red-sensitive pixels, and the blue-sensitive pixels in relation to other blue-sensitive pixels, which applies similarly at other points.

After the execution of the overall measurement, for example, after completed all-around rotation of the camera about the rotational axis with repeated recording of HDR image strips as required for a full-spherical HDR image, if desired the shutter can again be closed and it can be checked whether the sensitivity and/or the dark values have changed in the meantime, for example, due to temperature variations. It is apparent that it is advantageous where such drifts are to be compensated for to write the raw data, to write the calibration data or dark rates and sensitivity values and then, to perform the data preparation of the raw data in consideration of dark and reference measured values performed both before and also after the actual measurement.

Using the camera arrangement of the present invention, it can be ensured that the recorded data set represents a radiometrically and geometrically exact image of the surroundings.

Because the brightness (luminance) values for all color channels are exactly reconciled, alinearities have practically no effect over the large dynamic range and a highly linear data set is obtained, which also enables the observed brightness values to be adapted by computer. This has advantages above all where light fields have been recorded using the camera, to use them for the purposes of virtual reality, for example, in scenes of movies, for the rendering of products to be advertised in specific scenes, etc.

Therefore, inter alia, a method was described above for rapidly recording full-spherical images with high dynamic response, wherein a plurality of planar (multi-)color sensors, which are arranged in different partial beam paths and overlap as a whole, is rotated jointly with an objective into a specific position, an HDR measuring series is recorded at this position, and the color sensors are then rotated further jointly with the objective to record a planar image strip in a further position.

According to the above statements, a camera was also disclosed having a beam splitter arrangement and a plurality of planar image sensor chips arranged in the partial beam paths thereof, wherein multiple image sensor chips spaced apart from one another with gaps are arranged in a first partial beam path and a gap-overlapping image sensor chip is arranged in a further partial beam path for at least one gap.

A camera arrangement as described above was also described and disclosed, wherein more than three image sensor chips are arranged in a row, each with gaps in relation to one another, in the first partial beam path, preferably having gaps of at least essentially equal size in relation to one another, particularly preferably having a gap as wide as half of the sensor edge, and/or preferably in only one row, particularly preferably in a row which is vertical in use.

A camera as described above was also described and disclosed, wherein additionally and/or alternatively the beam splitter arrangement is formed using a solid beam splitter block, wherein the planar image sensor chips of the first partial beam path are adhesively bonded to a first surface of the solid beam splitter block, the at least one gap-overlapping image sensor chip of the further partial beam path is adhesively bonded to another exit surface of the beam splitter block, and wherein preferably the planar image sensor chips are contacted on the rear, particularly preferably with a shared printed circuit board for the image sensor chips of the first partial beam path and a further printed circuit board for the at least one gap-overlapping image sensor chip of the further partial beam path.

A camera arrangement as described above was also described and disclosed, wherein additionally and/or alternatively the image sensor chips are color sensors, preferably identical to one another.

A camera arrangement as described above was also described and disclosed, wherein additionally and/or alternatively a wide-angle objective is provided, preferably a fixed focal length objective of fixed aperture, and sufficiently many sensors are arranged in a row that a desired vertical spatial angle can be captured using a planar strip without further camera movements, preferably with a vertical opening angle of greater than 150°, particularly preferably over 180° of the 360° full-circle.

A camera arrangement as described above was also described and disclosed, wherein additionally and/or alternatively a drive is provided for the joint rotation of at least objective, beam splitter block, and image sensor chips about an axis which is generally vertical in use, preferably a vertical axis extending through the objective nodal point, and a means is provided for determining the rotational position, up to which the drive has rotated the camera, wherein this means for determining the rotational position is designed for determination of a rotational end position with subpixel accuracy, and wherein the camera furthermore is associated with a means for image data linkage of partial image data captured at various rotational positions to form an overall data set in response to the captured rotational stopping position.

A camera arrangement as described above was also described and disclosed, wherein additionally and/or alternatively the at least one light filter movable into the objective beam path between objective entry lens and image sensor chips, preferably at least one neutral density filter having an attenuation by at least the factor 100, and/or a color filter is provided, wherein the light filter is preferably a filter movable into the beam path as a replacement for another filter and preferably a means is provided to move the light filter into the beam path by excitation of an actuator controlled in response to the analysis of presently recorded image data.

A camera arrangement as described above was also described and disclosed, wherein additionally and/or alternatively a reference light source which is constant for at least a short time is provided for image sensor chip illumination, in particular a light-emitting diode which illuminates the beam splitter block, preferably illuminates it through a scattering arrangement, and an image sensor chip dimming means is provided, in particular a mechanical shutter, and a data analysis unit for determining a pixel sensitivity from values captured with dimming and with illumination only using the reference light source.

A camera arrangement as described above was also described and disclosed, wherein additionally and/or alternatively it is provided with a sequence controller, which is designed to decide whether pixel values in an individual measurement are above or below specific individual pixel limiting values which indicate overexposure or underexposure of individual pixels, whether a majority of pixel values are close to a low exposure threshold and/or close to a high exposure threshold, and to trigger a further exposure using longer or shorter exposure time and/or using activated or changed filter in the beam path in response to the exceeding or falling below of exposure limiting values thus ascertained.

A camera arrangement as described above was also described and disclosed, as additionally and/or alternatively described above, wherein the sequence controller is designed, during the decision about changed exposure conditions, to ignore pixels with regard to the statistical values previously captured thereby, in particular anomalous average and/or standard deviation values.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A camera comprising:
a beam splitter arrangement; and
a plurality of planar image sensor chips arranged in the partial beam paths thereof, which have nominal dynamic response for individual recordings of a finite range,
wherein multiple image sensor chips spaced apart from one another with gaps are arranged in a first partial beam path,
wherein a gap-overlapping image sensor chip is arranged in a further partial beam path for at least one gap,
wherein the beam splitter arrangement is formed using a solid beam splitter block,
wherein the planar image sensor chips of the first partial beam path are adhesively bonded to a first surface of the solid beam splitter block, and
wherein the at least one gap-overlapping image sensor chip of the further partial beam path is adhesively bonded to another exit surface of the beam splitter block, and in that
the camera is furthermore provided with a sequence controller to record images with a dynamic response higher than the finite dynamic range.

2-14. (canceled)
